(19) United States
(12) Patent Application Publication
(10) Pub. No.: US 2023/0115218 A1
(43) Pub. Date: Apr. 13, 2023

(54) COMPUTER SYSTEM FOR IMPROVING DATA INTEGRITY BY RESOLVING DEFAULT VALUES BASED ON CUSTOM OBJECTS, CRITERIA AND RULES

(71) Applicant: SAP SE, Walldorf (DE)

(72) Inventors: Rafiq Ahmed, Bengaluri (IN); Veeresh Devireddy, Bengaluri (IN); Varun Bhatia, Bengaluri (IN)

(21) Appl. No.: 17/839,857

(22) Filed: Jun. 14, 2022

(30) Foreign Application Priority Data
Oct. 8, 2021 (IN) 202111045834

(51) Int. Cl. G06F 16/23; G06F 8/65; H04L 67/02

(52) U.S. Cl. CPC G06F 16/2365; G06F 8/65; H04L 67/02

(57) ABSTRACT

Resolving default values based on custom objects, criteria and rules is described. The method includes instantaneous process of determining the default values of fields based on several associations and criteria among other group of fields. Further, several options are given to the user to define associations between fields and also define custom criteria to determine the target value. In addition, a generic rule engine is implemented in order to handle interactive events on the fields on the web application and re-evaluate the existing field values and update them accordingly. Thereafter, it significantly improves the whole process of assigning values to fields, increase data integrity, reduce manual intervention and errors.

### CLAIM OF PRIORITY

This application claims priority under 35 USC § 119(e) to India Provisional Application Serial No. 202111045834, filed on Oct. 8, 2021, the entire contents of which are hereby incorporated by reference.

### TECHNICAL FIELD

The present disclosure relates to computer-implemented methods, software and systems for automatically updating fields in web applications.

### BACKGROUND

A web application is application software that runs on a web server that accepts requests via network protocols, for example, hypertext transfer protocols (HTTP) or hypertext transfer protocol secure (HTTPS), used to distribute web pages. Web applications execute on a server and are accessed by a user on a client device through web browsers executing on the client device. The server and the client device are operatively coupled by an active network connection.

Web applications often involve data collection whereby users, operating client devices, enter data into web applications, such data being collected (and often processed) on the server. In some instances, a web application can provide a user with a collection of fields from which users can select values. Certain web applications can include numerous pages, each including multiple fields have corresponding values. Often, the fields are correlated such that the value of a particular field may depend on values of other fields. Not only is identifying appropriate values (for example, default values) for fields a cumbersome task, but incorrectly assigning values to fields can also pose significant risks.

### SUMMARY

This disclosure describes resolving default values based on custom objects, criteria and rules.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a representation of how data changes are propagated through a set of data.

FIG. 2 is an example of a computer system to determine and assign values to fields based on criteria, associations, rules and events.

FIG. 3 is an example of a flowchart of a method to determine and assign values to fields based on custom criteria, associations, rules and events.

FIG. 4 is an example of a flowchart of a method to update a primary data field causing a change to related data fields.

FIG. 5 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

This disclosure describes an improved computer system in general and is described using a human resources management (HRM) computer system(s). It can be implemented as computer-implemented tools or computer-implemented services (or both). In some implementations, the techniques described here can be implemented to fully automate the entire process of setting default and permissible values, dynamically based on pre-configured custom criteria which are executed and applied through a rule engine, based on any configured events like on-change, on-delete, on-save, etc.

Data integrity is a very important characteristic in computer systems. In short, data integrity means that a particular stored value is the accurate and correct value. As an example, in a purchase order scenario, if the purchaser order lists 10 items, but the computer system incorrectly lists only 9 items, that data error shows a lack of data integrity.

A decrease in data integrity can occur in any number of ways. The first way is through simple human error by typing in the wrong number into the relevant data field. Another way can occur when data is migrated from one system to another or when two different systems are merged together. In these examples one system may have more or fewer data fields than the other system. As an oversimplification, if a first data set has 10 data fields, but that data is migrating to a second system having 12 data fields, all of the records being migrated will have blank information in 2 out of the 12 data fields in the new system. These empty fields are a reflection of decreased data integrity compared to other records that will have all 12 data fields properly populated. In much larger and more complex systems with millions of records and perhaps hundreds of data fields spanning different areas (e.g., HR, purchasing, accounting, etc.), data integrity and trying to preserve data integrity can be extremely difficult.

An event is an operation of the computer system with respect to data elements on the web portal (or web application) invoked by interactions with the user. An event is to enfold the interactive operation on input data elements through input devices like a mouse, keyboard and other connected devices. The system is designed to capture these events and trigger corresponding action(s), either to update the data elements. A trigger is defined as a combination of event type and its corresponding action to be executed. Examples include, when the user provides an input to the web portal, changes an existing data field or input on the web portal or deletes the values from the web portal. Events can be associated with rules that in turn update values of fields as specified by those rules. When the event is invoked by the user, a computer system executes rules or computational code that logically corresponds to the event. A rule is a set of one or more terms and conditions defined by the user to validate the input data and perform logical comparisons. It often contains IF and/or Else conditions to control the process of data and operations. Executing the rule(s) determines default values of other data fields. For example, an “on-change” event is triggered when the value of an input field is changed by the user, an “on-delete” event is triggered when the value of an input field is deleted by the user, and an “on-save” event is triggered when the value of an input field is saved by the user. Similarly, other rules can be created and mapped to events that occur in one or more input elements in web applications.

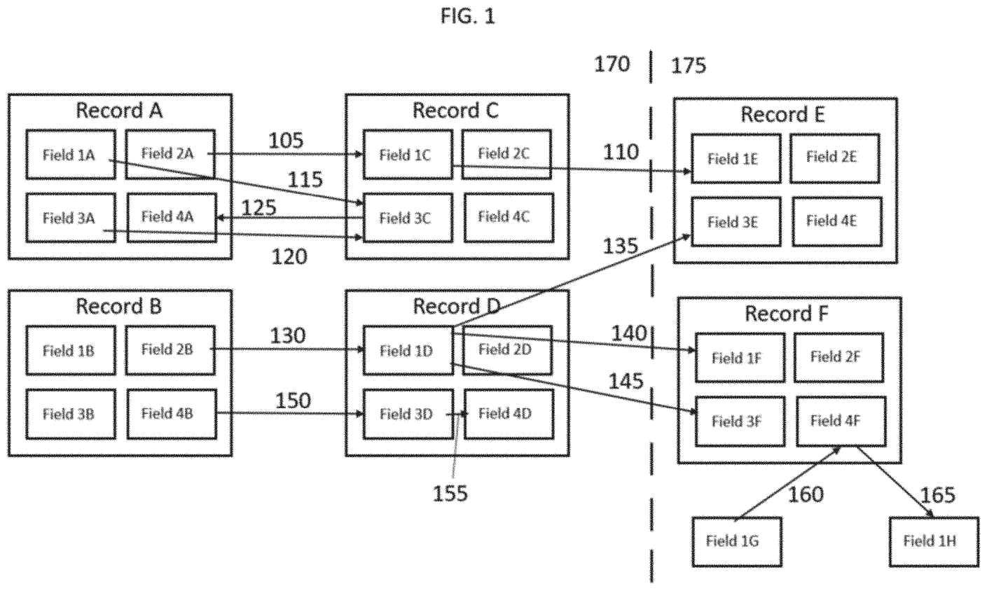

FIG. 1 is a representation of how data changes are propagated through a set of data. In FIG. 1, there are six records A, B, C, D, E, and F. A record is a grouping of data fields. As an example, an employee record would include data fields such as last name, first name, office street address, office state or region, office country, phone number, etc.

In FIG. 1, Field 2A in Record A is altered. This alteration could be a create, update or delete function to Field 2A. That alteration propagates to Field 1C in Record C as shown by arrow 105. In this example, Field 2A is a primary field as an alteration to it propagates to the secondary field shown as Field 1C. But that alteration to Field 1C propagates an alteration to Field 1E in Record E as shown by arrow 110.

Also shown in FIG. 1 are alterations made to Fields 1A and 3A. Those alterations in Fields 1A and 3A propagate to alterations in Field 3C as shown by arrows 115 and 120, respectively. The alterations in primary data Fields 1A and 3A could be an OR or an AND alteration to secondary Field 3C. That is, an alteration in either Field 1A or Field 3A may propagate as an alteration to Field 3C. Those propagations 115 and 120 would be independent of each other. In an alternative, the alterations in Fields 1A and 3A are dependent such that an alteration in both Field 1A and Field 3A are required to propagate as an alteration to Field 3C. Arrow 125 shows how an alteration in Field 3C propagates as an alteration to Field 4A.

Also shown in FIG. 1 is an alteration to Field 2B in Record B. That alteration in primary data Field 2B propagates to secondary data Field 1D as shown by arrow 130. The alteration in Field 1D in turn propagates to secondary data Fields 3E, 1F and 3F as shown by arrows 135, 140 and 145, respectively. Similarly, an alteration in primary data Field 4B propagates to secondary data Field 3D as shown by arrow 150. The subsequent alteration in data Field 3D propagates an alteration to secondary data Field 4D as shown by arrow 155.

It should be noted that not every data field needs to be associated with other data fields in a record or some other data object. Primary data Field 1G, that is not in a record, is altered and that alteration propagates to secondary data Field 4F as shown by arrow 160. That alteration to data Field 4F is then propagated to secondary data Field 1H as shown by arrow 165. Field 1H, like Field 1G, is not associated with other data fields in a record. While FIG. 1 shows various permutations of alteration propagations, other permutations are contemplated herein as needed.

Finally, primary and secondary data fields need not reside in the same domain or application. Records A, B, C and D, and their associated data fields, are located in domain or application 170 while Records E, F, and Fields 1G and 1H are shown in a different domain or application 175. An application is a software program that performs specific functions. Domains are collections of data and software applications that are generally in a specific area such as human resource, finance, legal, etc. In other implementations, FIG. 1 shows a data migration/integration where data fields in domains 170 and 175 are merged together.

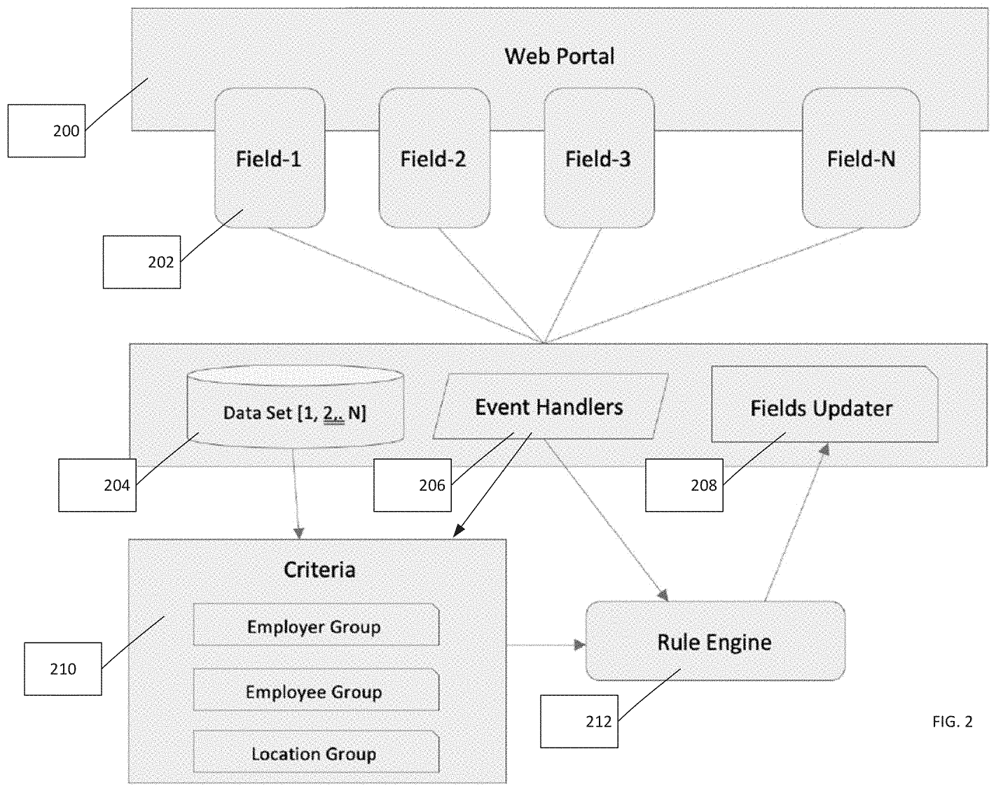

FIG. 2 is an example of a computer system, for example, an HRM system, to determine and assign values to fields based on criteria, associations, rules and events. The system includes multiple computer-implemented software modules. Each module can be implemented as computer-readable media (for example, non-transitory computer-readable media) storing computer instructions executable by one or more computer systems to perform operations described here.

The system includes a web portal 200 (or a web application). The web portal 200 is user interface (UI) designed to output data, receive data inputs, manage data, and other operations using a respective set of fields (for example, a field 202). The fields in the web portal 200 may be interrelated such that the value of one field influences the value (or values) of one or more other fields based on associations between the fields. In some implementations, the system can automatically select a value to be set for a field (or values to be set for multiple, interrelated fields) based on parameters and other data fields in the system. In addition, responsive to certain events, for example, on-change, on-save, on-delete, or such events, the system can auto-update the default values for other fields based on criteria and associations (described below).

The system includes a data set 204, for example, a computer-implemented database, that stores all values that can be assigned to the different fields 202. The data set 204 can be partitioned into multiple portions, each storing values unique to a corresponding field. For example, one field can be a Location field that represents the names of all locations in which a company operates. Another field can be a Legal Entities field operating within a company. The data set 204 can also store data in different configurations such as in records (e.g., interrelated fields) or by application type to which that data is associated (e.g., human resource data in one portion with something different like sales data in a different portion.) The data set 204 can store and associate values unique to each field. As described below, the data set can also store the interrelationships between various fields, for example, arrows 105-165 shown in FIG. 1. As a specific example, the data set 204 can store an interrelationship within the Pay Group field with different fields of, for example, the Employee Type fields, Location fields, Employee Grade fields and so on.

The system includes event handler 206. In some implementations, an event handler module determines which events occur in web portal 200 that may trigger propagation updates in secondary data fields. This includes determining if a changed data field is a primary data field. For example, if a user modifies a value in a field 202 shown in the web portal 200, then the event handler module 206 determines the type of event and if the changed data field is a primary data field. Modifications to data fields that are not primary data fields are detected by event handler 206, but as there are no downstream data fields impacted by a modified non-primary data field, no propagation actions need to take place. Administrators that deploy the system described in this disclosure can create event handlers 206.

The system includes a criteria module 210. In some implementations, the criteria module 210 stores, for example, in computer-readable media, conditions for specific fields. In response to an event on a field, criteria stored in the criteria module 210 is checked and the appropriate criteria from criteria module 210 is forwarded to rule engine 212. Some examples of relevant criteria include permission criteria (does the user attempting to modify a data field have permission to make that modification), data consistency criteria (is a particular modification not permitted as that change will cause data errors in secondary data fields if allowed), data showing the linkages between primary and secondary data fields (arrows 105-165 are examples of such linkages in FIG. 1), and default values to be inserted into some data fields. In some implementations, pre-determined criteria are delivered to enterprise companies who can later update them with custom criteria. For instance, an enterprise company can configure the pre-determined rules to get Pay Group fields based on Employee Type field and Location field, while another enterprise company can get it using a combination of Employer Group field and Legal Entity field.

The system includes a rule engine module 212. The rule engine module 212 implements one or more processes to perform the corresponding action(s). The rules engine module 212 receives data from event handlers 206 and from criteria 210 so as to determine the correct update data to input into the correct secondary data fields. In some instances, the secondary data fields will receive a default value based on the given set of event and criteria data. In some implementations, pre-determined rules are delivered to enterprise companies who can later update them with custom rules. For instance, an enterprise company can configure the pre-determined rules to get Pay Group fields based on Employee Type field and Location field, while another enterprise company can get it using a combination of Employer Group field and Legal Entity field.

The system includes a fields updater module 208. The fields updater module 208 receives output data from the rule engine 212 and updates the one or more of the fields 202 with updated values based on execution of one or more rules in the rule engine 212. The fields updater 208 may persist into data store 204 the source fields on which an event has been triggered, and if that source field is a primary field, it will persist into data store 204 the updated data in the respective target fields, also called secondary data fields, where they need to have new values. In addition, fields updater 208 will provide instructions to web portal 200 to update any updated secondary fields displayed or cached in anticipation of being displayed in the future on web portal 200. As an example, a user change to Field2A will cause execution of one or more rules in rule engine 212 via event handlers 206 where the outputs of those executed rules causes fields updater 208 to update other fields such as Field1C.

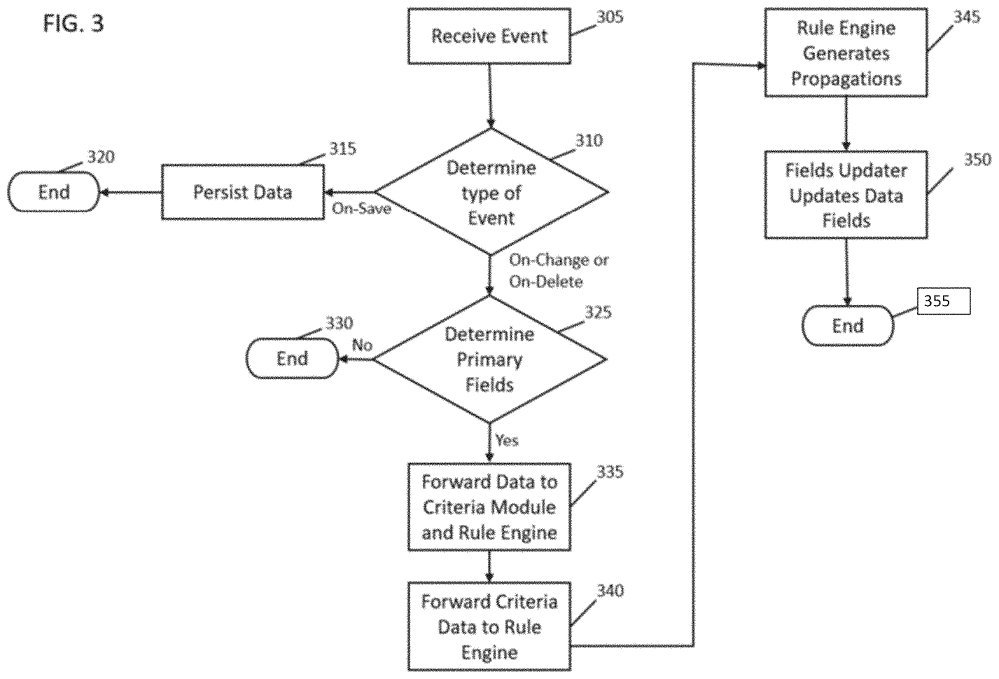

FIG. 3 is a flow chart outlining a method or process for updating data fields. The method or process begins at 305 where an event is received by the system. An event is an indication that a data field is being manipulated by a user. Some examples of events include on-change (a value in data field is being changed from one value to another value), on-delete (a value in a data is being removed such that the data field is left blank with no value in it) and on-save (values of data fields on the web portal 100 are persisted to data store 104). Events can also be initiated in a number of ways. For example, a user may use an input device such as a keyboard our touch device interfacing with web portal 100 to enter values into a data field that are updated (change from one value to another as an on-change event), deleted or saved where they are copied into data store 104 from web portal 100. Events may also be received from another computer system in a batch process where many data fields are being manipulated at a prescribed time. In this instance a web portal may not be used. Once received, the event is forwarded to event handler 106.

At step 310, event handler 106 determines the type of the event. If it is determined that the event is an on-save event, meaning that the user wishes to save the data that has recently been input and updated on web portal 100, then either all or only the recently updated data field values are written from web portal 100 to data store 104 at 315. The method then ends at 320 where it waits for another event.

At 325, the event handler 106 determines if any of the fields being changed or deleted are primary fields. For those data fields that are not primary data fields, the process with respect to those data fields ends at step 330. For the primary data fields, the method continues at 335.

It should be noted that there are multiple ways to determine if a data field is a primary data field or a secondary data field. One way is for data store 104 to maintain a table of the names or identifiers of all primary data fields. Thus, when an on-change or on-delete event is received by event handler 106, a lookup of that table can be done and if that name or identifier associated with the on-change or on-delete event is located within that table, the event handler 106 will process that altered value as a primary data field. If the name or identifier of that data field is not in this table, then this event can be processed as a secondary data field. Alternatively, when the event is transmitted from the web portal 100 or other device, it can include information indicating that the event is associated with a data field that is a primary field such as by using a flag or token.

At 335, the relevant data from the event is forwarded to the criteria module 210 and rule engine 212. This data will include the type of event (e.g., on-change vs. on-delete) as well as the name or identifier of the data field, perhaps a user ID of the person making the alteration and, if on-change, the new value to be input into the associated data field. This data is then used to query one or more additional data tables that are stored in data store 104. Those data tables may include other data such as permission data. A user attempting to alter a primary data field may not have permission to make the desired alteration (e.g., has permission for on-change, but not on-delete) or may not have permission to make any alterations to the primary data field. This second scenario may be seen more if a primary data field has secondary data fields in other domains or applications such that this permission data is designed to keep some users within their respective domains or applications. However, this permission data may also be used to restrict alterations from some users on data fields within their domain as well.

Criteria module 210 may also store data consistency data in a data table. This data is used if a user is allowed to alter value in a primary data field, but that alteration will cause data errors in secondary fields. One way to achieve this is through thresholds. A value in a primary data field may not be altered to go below a minimum threshold or above a maximum threshold as that value may cause a secondary data field to go below or above a threshold if the value from the primary data field is allowed to propagate to the secondary data field.

Criteria module 210 also stores linkages. A linkage is an indication to which secondary data fields the primary data field is linked. It will direct to which secondary fields an altered value in a primary data field is to go. The linkages are represented by the arrows in FIG. 1. Determining all the linkages is an iterative process. For example, a first received primary data field may be linked to a first, secondary data field. That first, secondary data field may also be a second primary data field with respect to a second, secondary data field. That second, secondary data field may also be a third primary data field with respect to a third, secondary data field. Thus, the data table is iteratively queried to output all secondary data fields altered via propagation from an altered primary data field.

Criteria module 210 may also store default values for some secondary data fields to be used in some circumstances. That is, if a primary data field alteration is received with a particular value (on-change) or no value (on-delete) it can forward a default value to an associated secondary data field. Whatever the relevant data is as determined by the criteria module 210, those criteria is forwarded to the rule engine 212.

At 345 the rule engine 212 executes one or more rules based on the event data it received from the event handler 106 and the criteria module 210. A particular rule may be selected based on the event data alone, the criteria data alone, or a combination of both the received event data and criteria. Rules may also be executed iteratively to ensure all of the relevant secondary data fields are updated via the linkages provided between the primary and secondary data fields.

The rules may be of any type. For example, some rules may be a replacement with a default value (e.g., if primary data field has value=X, then change value of secondary data field to Y). Other rules may be mathematical in nature (e.g., if primary data field has a new value of X, take X and multiply it by the value in a different data field and store the result in the associated secondary data field). Other rules may be logical (e.g., if the updated value of the primary data field is above a threshold, then set the logical value of a secondary data field to True). Other types of rules may also be written within the scope of this disclosure. When all of the new secondary values have been calculated or determined, rules engine outputs the new values with the associated secondary data field names or identifiers to the fields updater 108.

At 350, fields updater 108 updates all of the secondary data fields in web portal 100. By updating the displayed secondary data fields impacted by the user's alteration of a primary field, the user can see how that change impacted, negatively, positively or neutrally any of the secondary data fields. In an alternative embodiment, fields updater 108 could also update the corresponding secondary fields in the data store 104.

At 355, the process ends until another event is detected.

The use of default rules to enter data into a particular data field can be seen in the following example. When a company hires a new person, the HR department must enter the personal data information for that new employee. In the present example, once the HR representative enters primary data fields, data fields where changes therein will propagate to other data fields, those other, secondary data fields can be automatically filled in and stored with default values. Thus, by entering values for data fields such as, Job Title, Pay Scale, City of Employment and Country of Employment, a default rule can be used to generate his Annual Salary and display that value on the screen for the HR representative to check and then stored in a database. Subsequent to onboarding this new employee, if he changes locations to a new location, but maintains his present Job Title and Pay Scale level, where that new location has a stipend to account for a higher cost of living, a change in City of Employment and Country of Employment will automatically trigger an increased Annual Salary by using the HR criteria and executing the HR rules triggered by updates (e.g., on-change event) in the City of Employment and Country of Employment data fields.

In some implementations, a change event is triggered in response to receiving the input. The evaluating, the identifying and the displaying are implemented in response to the change event. In some implementations, default HR criteria, default HR rules and default interrelationships are generated and modified in response to input. The HR criteria include employer group criteria, employee group criteria and location group criteria.

In some implementations, the computer system described herein can be used in an HRM environment to determine and assign default values within web applications. To do so, such an HRM system can determine the default value of fields and set the default value to respective fields. The HRM system can evaluate the association between multiple fields and apply a set of custom criteria through the rules engine. The HRM system can observe the interactive events between fields to propagate field values, and can store the associations, criteria and default values in the cache for faster query response. That is, the HRM system can store a particular combination (or particular combinations) of associations and criteria that that result in default values, and, when the same combination is detected in the future, then retrieve the same default values and update fields in the web portals with those default values.

In some implementations, the HRM system can dynamically calculate the default value of the fields based on predefined associations and criteria. The default value of one field can influence the default value of one or more fields. By evaluating criteria, the HRM system can detect the influences and identify values that need to be updated based on the influences.

In some implementations, the HRM system can generate exactly one default value even though the underlying database can store numerous combinations of the data (i.e., the interrelationships). Once the HRM system determines the default value, it can set the default value to the input element of the web portal. The HRM system can evaluate several associations which are set by a user to determine the default value. The HRM system includes a component (for example, the criteria module) that gives an option to a user to define the associations between fields on the web portal. The HRM system can dynamically validate the associations to determine the default value of fields.

In some implementations, the HRM system can evaluate the custom criteria based on constant values like integer, string, Boolean, etc. The HRM system can include a component that gives the user an option to define a set of criteria on the web portal. For example, the HRM system can provide a web portal with rules fields into which the user can enter new rules or modify pre-defined rules. The HRM system can support both logical and conditional comparisons using the field values against given constant values.

In some implementations, the HRM system can detect triggered events such as on-change, on-save, on-add, on-delete or similar events. The HRM system includes a cache component (for example, a computer-readable medium) that can persist the recent default values for a given combination of fields, associations and criteria. The HRM system can serve default values being cached whenever any event triggers on the fields.

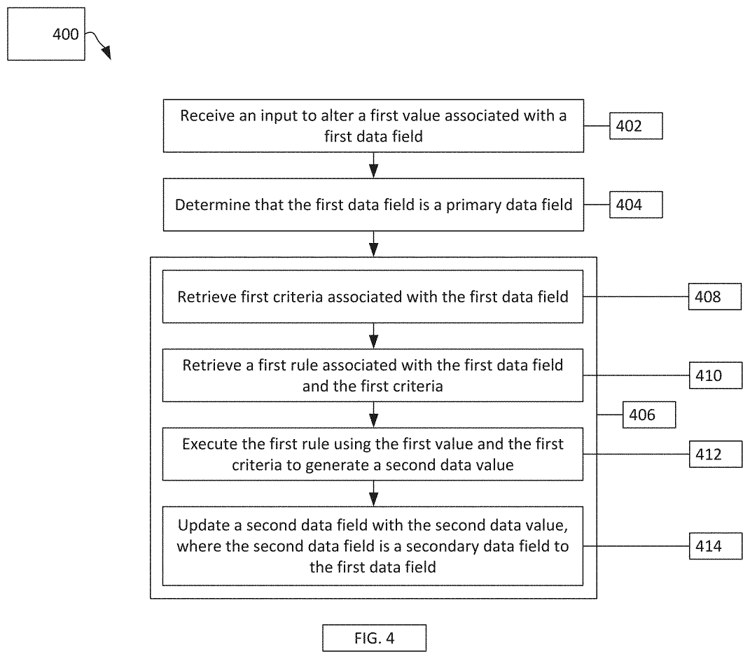

FIG. 4 is an example of a flowchart of a method 400 to update a primary data field causing changes to related data fields. The method or process 400 begins at step 402 where an input to alter a first value associated with a first data field is received. At step 404, a determination is made if the first data field is a primary data field. A primary data field is a data field in which a change of value associated with the primary data field propagates a change to a secondary data field. If it is determined that the first data field is a primary data field, then the steps collectively referenced by 406 are implemented. The steps 406 include step 408 where first criteria associated with the first data field are retrieved. At step 410, which is included in steps 406, a first rule associated with the first data field and the first criteria are retrieved. At step 412, which is included in steps 406, the first rule is executed using the first value and the first criteria to generate a second data value. At step 414, which is included in steps 406, a second data field is updated with the second data value. The second data field is a secondary data field to the first data field. To execute the rule, a data set is searched for a default value, and the second data value is set as the default value.

In some implementations, the first data field is determined to be a primary data field by reading from a data table. The data table includes a list of primary data fields. A determination is made if the second data field is also a primary data field. If it is determined that the second data field is a primary data field, then the following steps are implemented. Second criteria associated with the second data field is retrieved. A second rule associated with the second data field and the second criteria is retrieved. The second rule is executed using the second value and the second criteria to generate a third data value. A third data field is updated with the third data value. The third data field is a secondary data field to the second data field.

In some implementations, the first data field is in a first application, and the second data field is in a second, different application. The first data field is in a first domain, and the second data field is in a second, different domain. The second data value is determined based on a mathematical relationship to the first data value.

In some implementations, a rule is executed to determine if the first data value is above a first threshold and, if it is, then updating of the second data field is prohibited. A rule is executed to determine if the first data value is below a first threshold and, if it is, then the updating of the second data field is prohibited.

In sum, this disclosure describes a system and method of resolving and setting default values to fields of a web application on the computer. The method includes instantaneous process of determining the default values of fields based on several associations and criteria among other group of fields. Further, several options are given to the user to define associations between fields and define custom criteria to determine the target value. In addition, a generic rule engine is implemented in order to handle interactive events on the fields on the web application and re-evaluate the existing field values and update them accordingly. Thereafter, it significantly improves the whole process of assigning values to fields, increase data integrity, reduce manual intervention and errors.

Certain aspects are described in this disclosure in the context of an HRM computer system. The concepts described here can be implemented with respect to any system in which default values can be identified for respective fields based on certain conditions and rules. For example, the techniques described here can be implemented in most web applications in which default values can be automatically set in fields based on custom objects and rules. For example, in a Payment web application, the default value for a “Tax” field can be determined using the “Salary” and “Location” fields. In another example, in an e-commerce web application, the default value of the “Shipping Cost” field can be determined using “Location,” “Delivery Time,” “Dimension” and “Weight” fields. In a further example, in a pharmaceutical web application, the default value of “Drug Name” field can be determined based on several fields such as “Disease Type,” “Disease Condition,” “Drug Type” and “Age” fields. In addition, the techniques described here can be implemented in user interfaces of devices such as tablet computers, mobile phones, and the like, for example, to simplify selecting and setting default values in small screens.

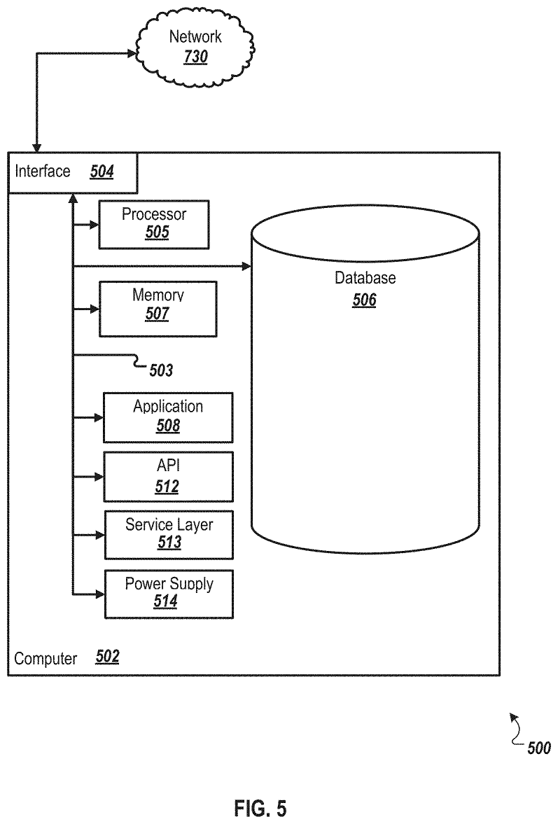

FIG. 5 is a block diagram illustrating an example computer system used to provide computational functionalities associated with described algorithms, methods, functions, processes, flows, and procedures as described in the present disclosure, according to some implementations of the present disclosure. The illustrated computer 502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI).

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a top level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both) over the system bus 503. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs.

The service layer 513 can provide software services to the computer 502 and other components (whether illustrated or not) that are communicably coupled to the computer 502. The functionality of the computer 502 can be accessible for all service consumers using this service layer. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 also includes a database 506 that can hold data for the computer 502 and other components connected to the network 530 (whether illustrated or not). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 can be an algorithmic software engine providing functionality according to particular needs, desires, or particular implementations of the computer 502 and the described functionality. For example, application 508 can serve as one or more components, modules, or applications. Further, although illustrated as a single application 508, the application 508 can be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery that can be configured to be either user-or non-user-replaceable. In some implementations, the power supply 514 can include power-conversion and management circuits, including recharging, standby, and power management functionalities. In some implementations, the power supply 514 can include a power plug to allow the computer 502 to be plugged into a wall socket or a power source to, for example, power the computer 502 or recharge a rechargeable battery.

There can be any number of computers 502 associated with, or external to, a computer system containing computer 502, with each computer 502 communicating over network 530. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

The operations described in this specification can be implemented as operations performed by a data processing apparatus on data stored on one or more computer-readable storage devices or received from other sources.

The term “processor” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well, for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user, for example, by sending web pages to a web browser on a user's client device in response to requests received from the web browser.

In some implementations, the data set 204 can store the values to be assigned to the different fields in tables. For example, the portions into which the data set 204 is partitioned includes tables. Each table stores logically related data. For example, a first table can be a Location Table that stores the names of all locations in which a company operates. A second table can be a Legal Entities Table that stores the names of all legal entities operating within the company. A third table can be an Employee Type Table that stores all the types of employees (e.g., executive, administrative, etc.). Because each table stores a range of logically-related values, each table represents a data object that can be accessed and from which a value can be retrieved based on criteria specified in the criteria module 210.

Each field 202 can be associated with a corresponding data object, i.e., a corresponding table. For example, a first field can be associated with the Location Table, which, as described above, stores the names of all locations in which the company operates. A second field can be associated with the Legal Entities Table, a third field can be associated with the Employee Table and so on. In some implementations, the criteria module 210 stores inter-relationships between the data objects, i.e., between the various tables in addition to the conditions base on the specific type of fields. When a value is selected in a field 202 displayed in the web portal, the inter-relationships stored in the criteria module 210 identify not only the data object, i.e., the table, in which the value is stored, but also all inter-related data objects, i.e., tables, that are related to the table in which the value is stored.

In some implementations, the rule engine module 212 implements one or more processes to handle changes in values presented in the fields based on the inter-relationships stored in the criteria module 210. The fields updater module 208 implements an outcome of a rule and updates fields presented in the web portal 200.

In an example operation, the criteria module 210 can store a graphical tree in which the tables and their inter-relationships are stored. A root of the tree can be a data object that includes all the tables and the values stored in each table. A first hierarchical level in the tree can include multiple data objects, each representing a corresponding tree. A second hierarchical level in the tree can include each value in each table. Each inter-relationship can be programmed as a key linking two tables. A field in the web portal 200 can show all values in the table, e.g., as a drop down box. When a user makes a selection from among the values in the table (e.g., the user selects an employee's location from the Employee Table), the rule engine 212 checks the criteria module table 210 to process the key in that table to identify all inter-related tables. The rule engine 212 then updates remaining fields in the web portal 200 to display values included in the corresponding inter-related table. By doing so, the rule engine 212 automatically narrows the universe of selectable values to only those values that satisfy the inter-relationship with the value selected in the initial selection (in this example, the employee's location). When the user makes a subsequent selection, the rule engine 212 repeats the processes described here to further automatically narrow the universe of selectable values in the other fields to only those values that satisfy the inter-relationships with the prior selections.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
receiving an input to alter a first value associated with a first data field;
determining if the first data field is a primary data field wherein a primary data field is a data field in which a change of value associated with the primary data field propagates a change to a secondary data field and if it is determined that the first data field is a primary data field;
retrieving first criteria associated with the first data field;
retrieving a first rule associated with the first data field and the first criteria;
executing the first rule using the first value and the first criteria to generate a second data value;
updating a second data field with the second data value wherein the second data field is a secondary data field to the first data field.

2. The method of claim 1 the determining if the first data field is a primary data field further comprising:
reading from a data table wherein the data table includes a list of primary data fields.

3. The method of claim 1 further comprising:
determining if the second data field is also a primary data field and if it determined that the second data field is a primary data field;
retrieving second criteria associated with the second data field;
retrieving a second rule associated with the second data field and the second criteria;
executing the second rule using the second value and the second criteria to generate a third data value;
updating a third data field with the third data value wherein the third data field is a secondary data field to the second data field.

4. The method of claim 1 wherein the first data field is in a first application and the second data field is in a second, different application.

5. The method of claim 1 wherein the first data field is in a first domain and the second data field is in a second, different domain.

6. The method of claim 1 wherein the second data value is determined based on a mathematical relationship to the first data value.

7. The method of claim 1 further comprising:
executing a rule to determine if first data value is above a first threshold and if it is, prohibiting the updating of the second data field.

8. The method of claim 1 further comprising:
executing a rule to determine if first data value is below a first threshold and if it is, prohibiting the updating of the second data field.

9. The method of claim 1, wherein executing the rule further comprises:
searching a data set for a default value; and
setting the second data value as the default value.

10. A system comprising:
one or more computers; and
a computer-readable medium coupled to the one or more computers having instructions stored thereon which, when executed by the one or more computers, cause the one or more computers to perform operations comprising:
receiving an input to alter a first value associated with a first data field;
determining if the first data field is a primary data field wherein a primary data field is a data field in which a change of value associated with the primary data field propagates a change to a secondary data field and if it is determined that the first data field is a primary data field;
retrieving first criteria associated with the first data field;
retrieving a first rule associated with the first data field and the first criteria;
executing the first rule using the first value and the first criteria to generate a second data value;
updating a second data field with the second data value wherein the second data field is a secondary data field to the first data field.

11. The system of claim 10, wherein the operations for determining if the first data field is a primary data field further comprise:
reading from a data table wherein the data table includes a list of primary data fields.

12. The system of claim 10, wherein the operations further comprise:
determining if the second data field is also a primary data field and if it determined that the second data field is a primary data field;
retrieving second criteria associated with the second data field;
retrieving a second rule associated with the second data field and the second criteria;
executing the second rule using the second value and the second criteria to generate a third data value;
updating a third data field with the third data value wherein the third data field is a secondary data field to the second data field.

13. The system of claim 10, wherein the first data field is in a first application and the second data field is in a second, different application.

14. The system of claim 10, wherein the first data field is in a first domain and the second data field is in a second, different domain.

15. The system of claim 10, wherein the second data value is determined based on a mathematical relationship to the first data value.

16. The system of claim 10, wherein the operations further comprise:
executing a rule to determine if first data value is above a first threshold and if it is, prohibiting the updating of the second data field.

17. The system of claim 10, wherein the operations further comprise:
executing a rule to determine if first data value is below a first threshold and if it is, prohibiting the updating of the second data field.

18. The system of claim 10, wherein the operations for executing the rule further comprises:
searching a data set for a default value; and
setting the second data value as the default value.

19. A non-transitory computer-readable medium storing computer instructions executable by one or more computers to perform operations comprising:
receiving an input to alter a first value associated with a first data field;
determining if the first data field is a primary data field wherein a primary data field is a data field in which a change of value associated with the primary data field propagates a change to a secondary data field and if it is determined that the first data field is a primary data field;
retrieving first criteria associated with the first data field;
retrieving a first rule associated with the first data field and the first criteria;
executing the first rule using the first value and the first criteria to generate a second data value;
updating a second data field with the second data value wherein the second data field is a secondary data field to the first data field;
determining if the second data field is also a primary data field and if it determined that the second data field is a primary data field;
retrieving second criteria associated with the second data field;
retrieving a second rule associated with the second data field and the second criteria;
executing the second rule using the second value and the second criteria to generate a third data value;
updating a third data field with the third data value wherein the third data field is a secondary data field to the second data field.

20. The medium of claim 19, wherein the first data field is in a first application and the second data field is in a second, different application.
